(19) United States
(12) Patent Application Publication
(10) Pub. No.: US 2021/0187385 A1
(43) Pub. Date: Jun. 24, 2021

(54) Convert a drawn picture to the playfield of an electronic pinball game

(71) Applicant: Chu Kwok Woo, Kowloon (HK)

(72) Inventor: Chu Kwok Woo, Kowloon (HK)

(21) Appl. No.: 16/718,203

(22) Filed: Dec. 18, 2019

(51) Int. Cl. A63F 7/30; A63F 7/02; G06F 3/0488; A63F 9/24

(52) U.S. Cl. CPC A63F 7/30; A63F 7/027; G06F 3/04883; A63F 2007/303; A63F 2009/2457; A63F 2009/2461; A63F 9/24

(57) ABSTRACT

A software type pinball game enable players to change the background picture of the playfield and also to configure the game functional components via a drawn picture. Players can draw the picture on a paper, captures into any electronic image device, or using an electronic drawing device or application software to draw that picture into an electronic format and send to the game for conversion of game components.

### FIELD OF THE INVENTION

This invention relates to the software type of pinball games, particularly, for players to design the playfield of the game.

### BACKGROUND OF THE INVENTION

Pinball game is available on every electronic entertainment platform, like mobile phone, computer, arcade game, and TV game. Once the game program launched to public, the playfield components shall not be modified or re-configured to fit for specific requirements of competition or individual player interest. The invention allows players to set a specific playfield components layout through a hand drawing.

### BRIEF DESCRIPTIONS OF THE DRAWINGS

FIG. 1 is the operation flow of the system to convert a drawn picture to the playfield of an electronic pinball game.

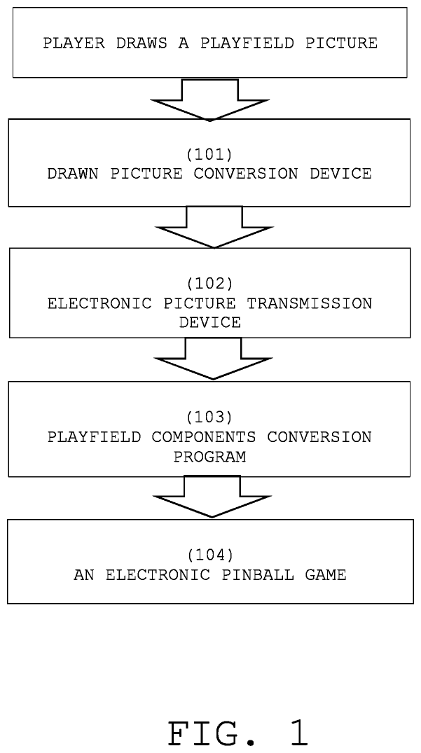

FIG. 2 is the embodiment 1 to show the operation flow of the playfield picture drawn on a piece of paper.

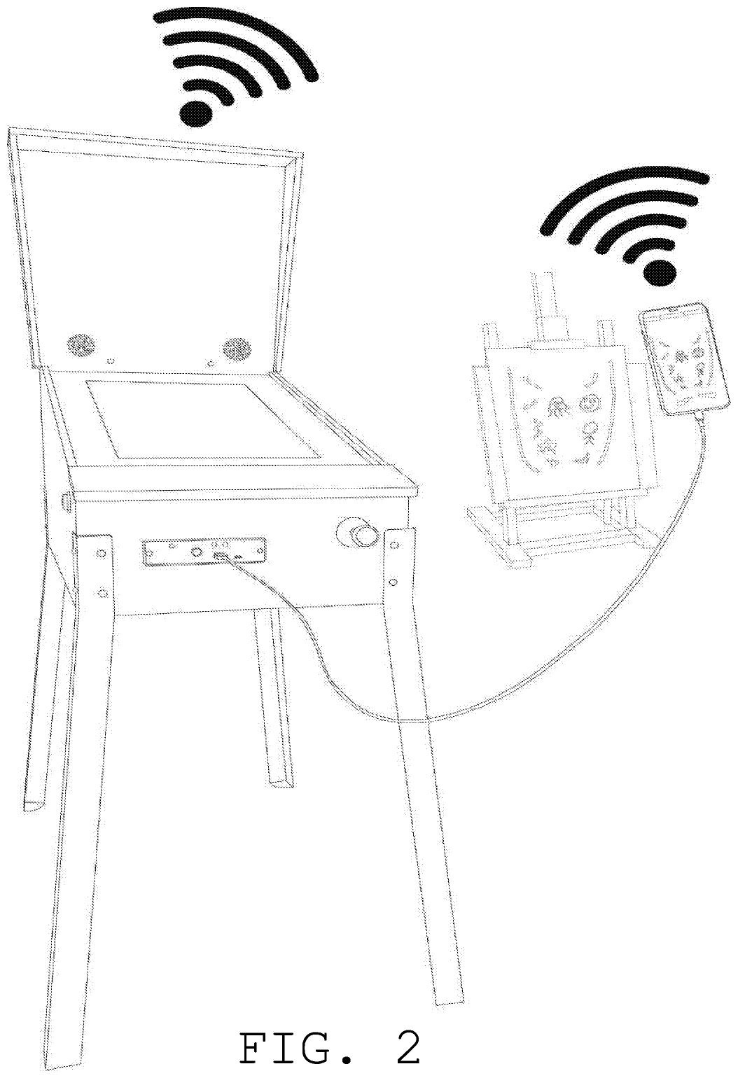

FIG. 3 is the embodiment 2 to show the operation flow of the playfield picture drawn onto an electronic device.

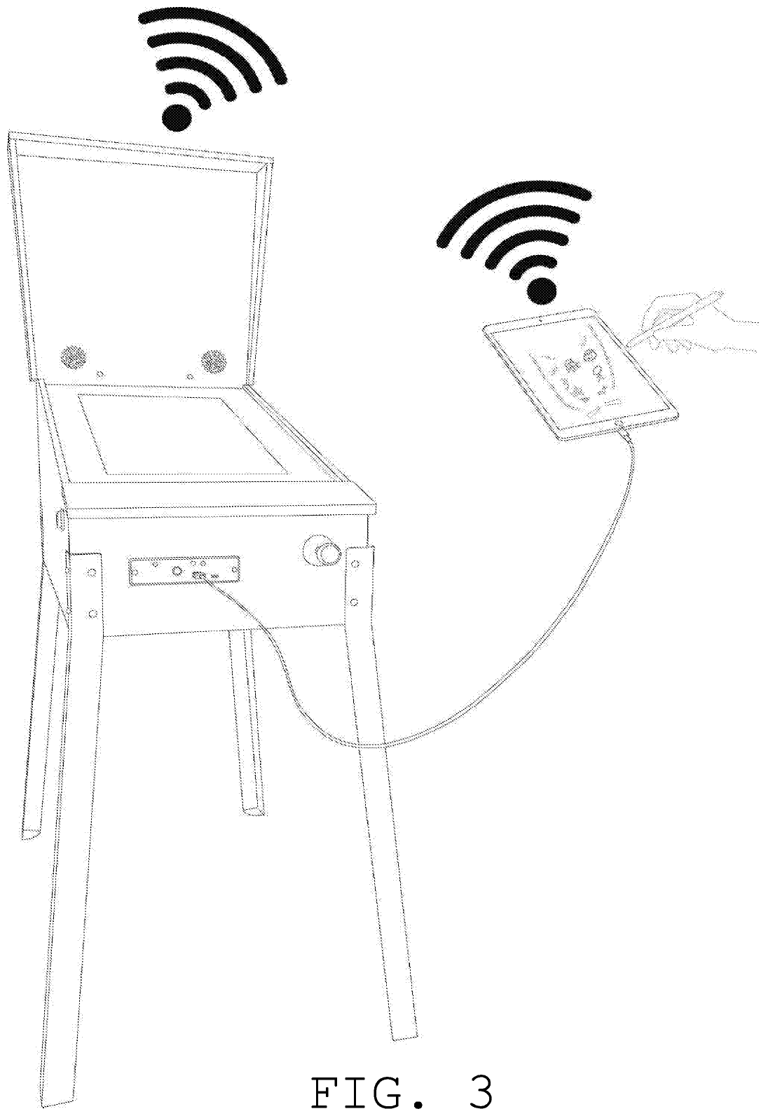

### DETAILED DESCRIPTIONS OF THE EMBODIMENTS

A system to convert a drawn picture to the playfield of an electronic pinball game, which enable players to re-configure the playfield background picture and also the games' components. The conversion system shall be applied for a software type pinball game played on an electronic display, such as LCD panel or TV display, in order that the playfield of the game can be changed as per the drawn pictures.

The system comprise (101) a drawn picture conversion device; (102) an electronic picture transmission device; (103) a playfield components conversion program; and (104) an electronic pinball game.

In embodiment 1, player draws the playfield picture on a piece of paper, and use a digital camera to take photos of the picture, wherein the digital camera converts the playfield picture into an electronic format and performed as a drawn picture conversion device.

In embodiment 2, player draws the playfield picture directly on the drawn picture conversion device and save into an electronic format, wherein the drawn picture conversion device can be a tablet computer, a mobile phone or a notebook computer.

When the drawn picture is stored into an electronic format, it will be sent to the playfield components conversion program to identify the games' components from the playfield pictures.

Wherein the components will be converted from picture includes Plungers, Flippers, Bumpers, Ramps, Kickers, Slingshots, Targets, Holes, Spinners, Rollovers, Switches and Stoppers. The general descriptions of the component's functions as follows:

Plunger: pinball launching system

Flippers: player controlled levers

Bumpers: round knob to push pinball away

Kickers: a pad to propel the pinball away upon impact

Slingshots: a pad to propel the pinball away upon impact

Targets: a static targets to record when a pinball strikes

Holes: direct pinballs into a hole

Spinners: causing pinball to spin

Rollovers: activate targets when a ball rolls over

Switches: the area that is blocked off after pinball passes through

Stoppers: a small pole to block area of flippers.

The pinball game will be loaded with the drawn playfield picture on the background and configured with the identified game components. The whole conversion process shall be done and player can start a new configured pinball game.

The invention claimed is:

1. A system to convert a drawn picture to the playfield of an electronic pinball game comprising:
an electronic pinball game;
a playfield components conversion program;
an electronic picture transmission device;
a drawn picture conversion device;
wherein when user draws a picture for a pinball game playfield, the drawn picture conversion device will convert and save the drawn picture into an electronic format for transmission and conversion;
wherein the electronic picture transmission device will transmit and receive the electronic form of the drawn picture from the drawn picture conversion device to the playfield components conversion program;
wherein the playfield components conversion program will take the conversion of the electronic form of drawn picture into the playfield and the pinball game components;
wherein when the conversion is finished, the playfield of the pinball game will be loaded with the drawn picture and also with the identified pinball game components.

2. The system of claim 1,
wherein an electronic pinball game shall be played on an electronic display, so as the playfield of the pinball game can be electronically changed;

3. The system of claim 1,
wherein the playfield components conversion program shall be used to convert the electronic drawn picture into the components on the playfield,
wherein the program shall identify the pinball game components from a drawn picture;
wherein the playfield components that will be identified shall include Plunger, Flippers, Bumpers, Ramps, Kickers, Slingshots, Targets, Holes, Spinners, Rollovers, Switches and Stoppers;
wherein the background picture of the playfield can also be changed by the same drawn picture;
wherein the program may be attached to the pinball game program, or the electronic picture transmission device;

4. The system of claim 1,
wherein an electronic picture transmission device used for transmitting and receiving the electronic form of the drawn picture from the picture conversion device;
wherein no limitation for the transmission media, and it can be conducted through any wired or wireless system;

5. The system of claim 1,
wherein a drawn picture conversion device comprising for converting a drawn picture into an electronic format,
wherein the drawn picture can be captured into the device, or the picture can be drawn directly on the device;
